(19) United States
(12) Patent Application Publication
(10) Pub. No.: US 2025/0243933 A1
(43) Pub. Date: Jul. 31, 2025

(54) ELECTRIC UTILITY VEHICLE WITH TOW MODE

(71) Applicant: The Toro Company, Bloomington, MN (US)

(72) Inventors: Jeffrey J. Barkow, Bloomington, MN (US); Ryan J. Foss, St. Paul, MN (US)

(21) Appl. No.: 19/042,508

(22) Filed: Jan. 31, 2025

Related U.S. Application Data
(60) Provisional application No. 63/627,531, filed on Jan. 31, 2024.

(51) Int. Cl. F16H 63/48

(52) U.S. Cl. CPC F16H 63/483

(57) ABSTRACT

A utility vehicle having a power control system including a key switch with multiple positions corresponding to modes including a park mode, where a parking brake mechanism is engaged for stationary stability; an operation mode, enabling directional movement by disengaging the parking brake and activating the drive arrangement; and a tow mode, which disengages the parking brake and sets the drive arrangement to neutral, allowing for manual maneuvering of the vehicle in either a forward or reverse direction.

### RELATED APPLICATION

This application claims priority to U.S. Provisional Patent Application Ser. No. 63/627,531, filed on Jan. 31, 2024, the entirety of which is incorporated herein by reference.

### TECHNICAL FIELD

The present invention generally relates to utility vehicles, and more particularly to electric utility vehicles with improved brake release mechanisms for ease in towing.

### BACKGROUND

In the realm of utility vehicles, particularly those powered by electricity, a significant challenge has been the handling and maneuvering of these vehicles in situations where they cannot be driven, such as during battery depletion or mechanical failures. Traditional electric utility vehicles are often equipped with parking brake systems that, while effective in immobilizing the vehicle under normal circumstances, can become a hindrance when the vehicle needs to be moved manually. This is especially problematic in cases where the battery is too low to power the vehicle's drive system or inoperative, rendering the electronic controls for disengaging the parking brake ineffective.

### SUMMARY

Embodiments described herein can provide a utility vehicle with advanced control and operational features, and may incorporate various aspects as disclosed herein in any combination. In some examples, the utility vehicle is powered by a power supply including one or more rechargeable batteries, providing the necessary energy for its functions. In some examples, the utility vehicle has a drive arrangement including at least one electric motor and one or more driven ground engaging members (e.g., wheels, tracks, etc.), facilitating operational movement of the utility vehicle.

In some examples, the utility vehicle includes an engageable parking brake mechanism which can be activated or deactivated to either immobilize the utility vehicle or allow movement, respectively. In some examples, the utility vehicle includes a power control system with a key switch having multiple positions, each position corresponding to a different operational mode of the vehicle.

In some examples, the utility vehicle can include an electronic controller configured to enable the vehicle to operate in at least three distinct modes, including a parking mode in which the parking brake is engaged, inhibiting the utility vehicle from moving, an operation mode in which the parking brake is disengaged, enabling the electric motor to drive the utility vehicle in forward or reverse upon pressing an accelerator pedal, and a tow mode in which the parking brake is disengaged and the drive arrangement is in neutral, enabling the vehicle to be manually rolled.

In some examples, the utility vehicle transitions to the tow mode only at speeds of less than or equal to a determined maximum speed (e.g., about 1 mph) and only after holding the key switch in a specified position for a predetermined length of time (e.g., about 5 seconds). In some examples, the engageable parking brake mechanism can be disengaged even when the power supply is in a low charge state, ensuring that the vehicle can be moved in emergencies. In some examples, the utility vehicle includes a display that provides visual indications of the controller mode, for example, to display when the utility vehicle is in the tow mode.

Another aspect of the present disclosure provides a utility vehicle including a power supply, a drive arrangement, an engageable parking brake mechanism, a power control system with a key switch having a plurality of positions, and a controller for selectively operating the utility vehicle in one of three modes, including, a park mode, wherein the engageable parking brake mechanism is engaged, an operation mode, wherein the engageable parking brake mechanism is disengaged and the drive arrangement is controllable to drive the utility vehicle in a forward or reverse direction, and a tow mode, wherein the engageable parking brake mechanism is disengaged and the drive arrangement is in a neutral position to enable the utility vehicle to be manually rolled in the forward or reverse direction.

In some examples, the power supply comprises one or more rechargeable lithium-ion batteries. In some examples, the drive arrangement comprises at least one electric motor and one or more driven ground engaging members.

In some examples, the plurality of positions of the key switch include an OFF position, an ON position, and TRANSPORT position corresponding to the park mode, operation mode, and tow mode of the controller.

In some examples, when the controller is in the park mode, the engageable parking brake mechanism is engaged to inhibit rotation of the one or more driven ground engaging members. In some examples, when the controller is in the operation mode, the engageable parking brake mechanism is disengaged to enable the at least one electric motor to drive the one or more driven ground engaging members upon manually pressing an accelerator pedal.

In some examples, the controller transitions to the tow mode only when a speed of the utility in the vehicle is less than or equal to a predetermined speed. In some examples, the predetermined speed is about 1 mph. In some examples, the controller transitions to the tow mode only when the key switch is held in at least one of the plurality of positions for a predetermined length of time. In some examples, the predetermined length of time is 5 seconds.

In some examples, when the controller is in the tow mode, electrical power from the power supply is applied to the engageable parking brake mechanism to disengage the engageable parking brake mechanism. In some examples, the engageable parking brake mechanism can be disengaged when the power supply is in a low charge state (e.g., having a charge of at least about 2.75 volts).

In some examples, the utility vehicle further includes a display or user interface. In some examples, the user interface is configured to visually indicate when the controller is in the tow mode.

A method of operating a utility vehicle is also disclosed and includes providing a utility vehicle having a power supply, a drive arrangement, an electromagnetic parking brake mechanism that is in a locked state when deenergized, and a key switch having OFF, ON, and TRANSPORT positions. The method includes rotating the key switch from the OFF position to the TRANSPORT position, holding the key switch in the TRANSPORT position for a predetermined length of time, confirming a speed of the utility vehicle is below a predetermined threshold speed, and transitioning the utility vehicle to a tow mode by disengaging the electromagnetic parking brake mechanism and configuring the drive arrangement to enable manual rolling of the utility vehicle. In some examples, the predetermined length of time is about 5 seconds. In some examples, the predetermined threshold speed is about 1 mile per hour. In some examples, the method includes displaying a neutral symbol on a user interface to indicate the utility vehicle is in the tow mode. In some examples, disengaging the electromagnetic parking brake mechanism includes applying electrical power from the power supply to the parking brake mechanism. In some examples, the electromagnetic parking brake mechanism is disengageable when the power supply has a charge of at least about 2.75 volts. In some examples, the method includes releasing the key switch after the predetermined length of time and allowing the key switch to return to the ON position while maintaining the utility vehicle in the tow mode. In some examples, the method includes terminating the tow mode by rotating the key switch to the OFF position. In some examples, the method includes automatically engaging the electromagnetic parking brake mechanism upon termination of the tow mode. In some examples, configuring the drive arrangement includes placing a transmission of the drive arrangement in a neutral position.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a perspective view of a utility vehicle, in accordance with an embodiment of the disclosure.

FIG. 2 is a schematic view of the utility vehicle of FIG. 1, in accordance with an embodiment of the disclosure.

FIG. 3 is a partial perspective view of the utility vehicle of FIG. 1, illustrating portions of a control panel, in accordance with an embodiment of the disclosure.

FIG. 4 is a schematic view of a power control system usable with the utility vehicle of FIG. 1, in accordance with an embodiment of the disclosure.

FIG. 5 is a block diagram of an example non-transitory computer readable medium including a set of instructions executable by a processor of the power control system of FIG. 4, in accordance with an embodiment of the disclosure.

FIG. 6 is a screenshot of a user interface indicating that engageable parking brake mechanism is engaged, in accordance with an embodiment of the disclosure.

FIG. 7 is a screenshot of the user interface indicating that the power control system of FIG. 4 is in an operation mode, in accordance with an embodiment of the disclosure.

FIG. 8 is a screenshot of the user interface indicating that the power control system of FIG. 4 is in a transport mode, in accordance with an embodiment of the disclosure.

FIG. 9 is a flow diagram illustrating an example method of controlling the utility vehicle of FIG. 1, in accordance with an embodiment of the disclosure.

FIG. 10 is an electrical schematic of the utility vehicle of FIG. 1, in accordance with an embodiment of the disclosure.

FIG. 10A is a view of a portion of the electrical schematic shown in FIG. 10, as indicates at 10A in FIG. 10.

FIG. 10B is a view of a portion of the electrical schematic shown in FIG. 10, as indicates at 10B in FIG. 10.

FIG. 10C is a view of a portion of the electrical schematic shown in FIG. 10, as indicates at 10C in FIG. 10.

FIG. 11 is a perspective view of a drive arrangement and an electromagnetic parking brake mechanism usable with the vehicle 100 shown in FIG. 1.

FIG. 12 is a partial cross-sectional view of the drive arrangement and electromagnetic parking brake mechanism shown in FIG. 11.

The figures are rendered primarily for clarity and, as a result, are not necessarily drawn to scale. Moreover, various structure/components, including but not limited to fasteners, electrical components (wiring, cables, etc.), and the like, can be shown diagrammatically or removed from some or all of the views to better illustrate aspects of the depicted embodiments, or where inclusion of such structure/components is not necessary to an understanding of the various exemplary embodiments described herein. The lack of illustration/description of such structure/components in a particular figure is, however, not to be interpreted as limiting the scope of the various embodiments in any way.

### DETAILED DESCRIPTION

In the following detailed description of illustrative embodiments, reference is made to the accompanying figures of the drawing which form a part hereof. It is to be understood that other embodiments, which may not be described and/or illustrated herein, are certainly contemplated.

All headings provided herein are for the convenience of the reader and should not be used to limit the meaning of any text that follows the heading, unless so specified. Moreover, unless otherwise indicated, all numbers expressing quantities, and all terms expressing direction/orientation (e.g., vertical, horizontal, parallel, perpendicular, etc.) in the specification and claims are to be understood as being modified in all instances by the term “about.” The term “and/or” (if used) means one or all of the listed elements or a combination of any two or more of the listed elements. “I.e.” is used as an abbreviation for the Latin phrase id est and means “that is.” “E.g.,” is used as an abbreviation for the Latin phrase exempli gratia and means “for example.”

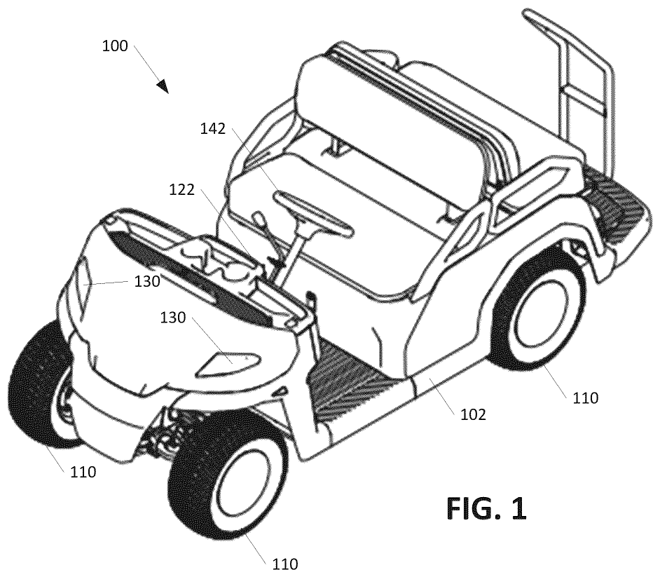

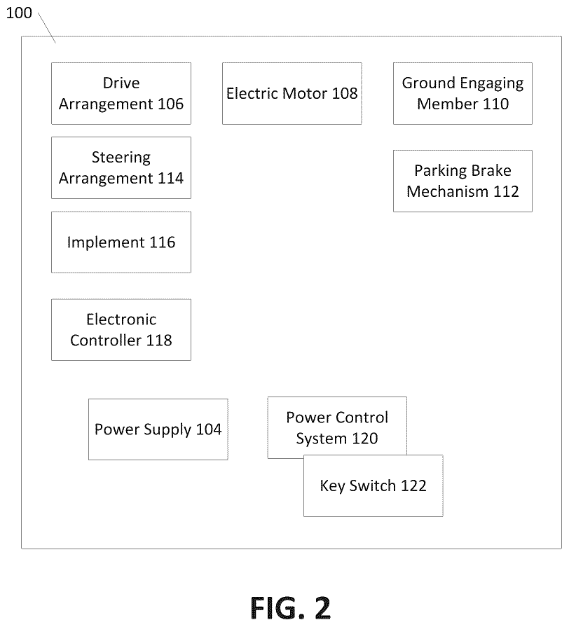

With reference to the figures of the drawing, wherein like reference numerals designate like parts and assemblies throughout the several views, FIGS. 1-2 illustrate a utility vehicle 100 in accordance with an exemplary embodiment of the present disclosure. This type of utility vehicle 100 can assume a number of different configurations, and may fall under various categories such as light transportation vehicles, multipurpose utility vehicles, maintenance vehicles, shuttle vehicles, worksite vehicles, neighborhood electric vehicles, and more.

While shown as a self-propelled, utility vehicle 100 including a driver's seat (also referred to herein simply as a “vehicle” or “machine”), it should be noted that this is merely one example of the broader applicability of the concepts presented. The principles and features described herein are not confined to vehicles with driver's seats but extend to other configurations, including walk-behind or rear standing platform vehicles, as well as various types of wheeled or tracked maintenance machinery (e.g., mowers, debris management systems like blowers, vacuums, sweepers, etc.), and general-purpose utility machines. In this context, the terms “utility vehicle” and “utility machine” are inclusively defined to cover vehicles and machines designed for use on a variety of surfaces, whether turf (i.e., grass) or non-turf (e.g., concrete).

It is noted that the terms “have,” “includes,” “comprises,” and variations thereof do not have a limiting meaning and are used in the open-ended sense to generally mean “including, but not limited to,” where the terms appear in the accompanying description and claims. Further, “a,” “an,” “the,” “at least one,” and “one or more” are used interchangeably herein. Moreover, relative terms such as “left,” “right,” “front,” “fore,” “forward,” “rear,” “aft,” “rearward,” “top,” “bottom,” “side,” “upper,” “lower,” “above,” “below,” “horizontal,” “vertical,” and the like can be used herein and, if so, are from the perspective of one operating the utility vehicle 100 while the utility vehicle 100 is in an operating configuration, e.g., while the utility vehicle 100 is positioned on a ground surface as shown in FIG. 1. These terms are used only to simplify the description, however, and not to limit the interpretation of any embodiment described.

While the general construction of the utility vehicle 100 is not necessarily central to an understanding of exemplary embodiments (e.g., other vehicle configurations are certainly contemplated), a general construction of the utility vehicle 100 is briefly described below. As shown in FIG. 1, in some embodiments, the utility vehicle 100 can include a chassis or frame 102, serving as a base to support the various other components of the utility vehicle 100. For instance, in one embodiment, the frame 102 can be constructed from welded steel, providing robustness and durability, and optionally treated with a powder coat finish for enhanced protection and longevity.

As further shown in FIG. 2, in some embodiments, the utility vehicle 100 can feature an all-electric design with an electrical or power control system 120 equipped with a power supply 104 that provides energy to a drive arrangement 106, thereby enabling the propulsion of the utility vehicle 100. In embodiments, the power supply 104 can comprise a battery, a generator, or a combination thereof. Notably, some embodiments allow for the onboard recharging of the power supply 104, enhancing convenience and operational efficiency. Alternatively, other embodiments enable the power supply 104 to be replaced or exchanged upon depletion, offering flexibility in power management. In some embodiments, the power supply 104 can comprise of one or more rechargeable lithium-ion batteries, known for their high energy density and longevity.

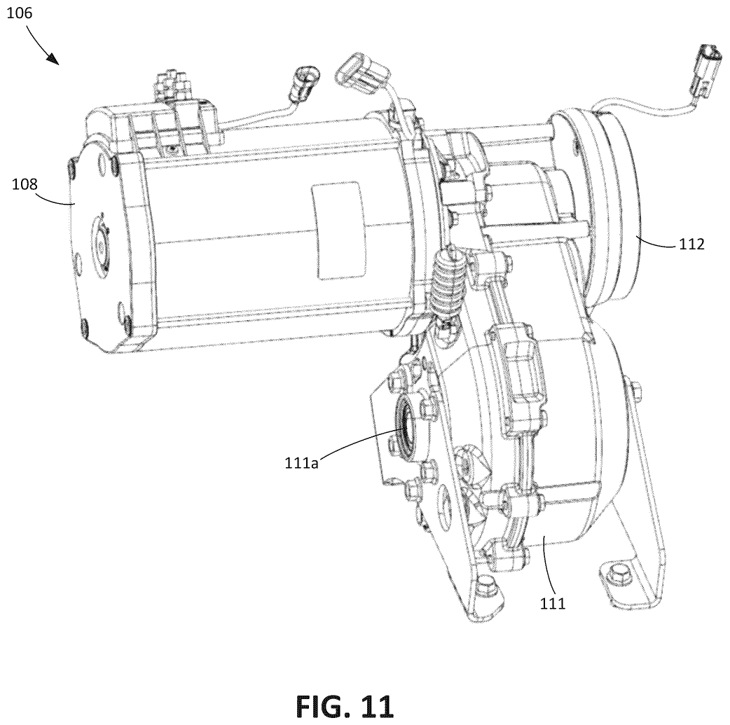

In embodiments, the drive arrangement 106 can comprise one or more electric motors 108 operated by a motor controller 109 and configured to drive one or more ground engaging members 110 (e.g., wheels, tracks, etc.), facilitating operational movement of the utility vehicle. For example, in one embodiment, the one or more electric motors 108 can be brushless, high torque induction motors enabling continuous power output to the one or more ground engaging members 110. In some embodiments, the one or more electric motors 108 can be coupled directly to the one or more ground engaging members 110. In other embodiments, the one or more ground engaging members 110 can be coupled to the one or more electric motors via a transmission, differential or other geared mechanism. For example, and as shown at FIGS. 11, a transmission 111 including a plurality of intermeshed gears can be coupled to the electric motor 108 to provide a speed reduction between the motor and an output 111a of the transmission coupled to one or more ground engaging members 110. In one example, the transmission is configured to provide a speed reduction or gear ratio between the motor speed and the output 111a of between 10:1 and 20:1, for example, a speed reduction or gear ratio of about 17:1. In one aspect, the transmission 111 may also be referred to as a reducer or gearbox. In some embodiments, the transmission can be capable of mechanically shifting between positions such as high, low, park and optionally neutral. In some examples, the transmission 111 can be configured with one or more pulleys and belts instead of gears. As further depicted in FIG. 2, the utility vehicle 100 can further include a steering arrangement 114 to provide steering control of the utility vehicle 100.

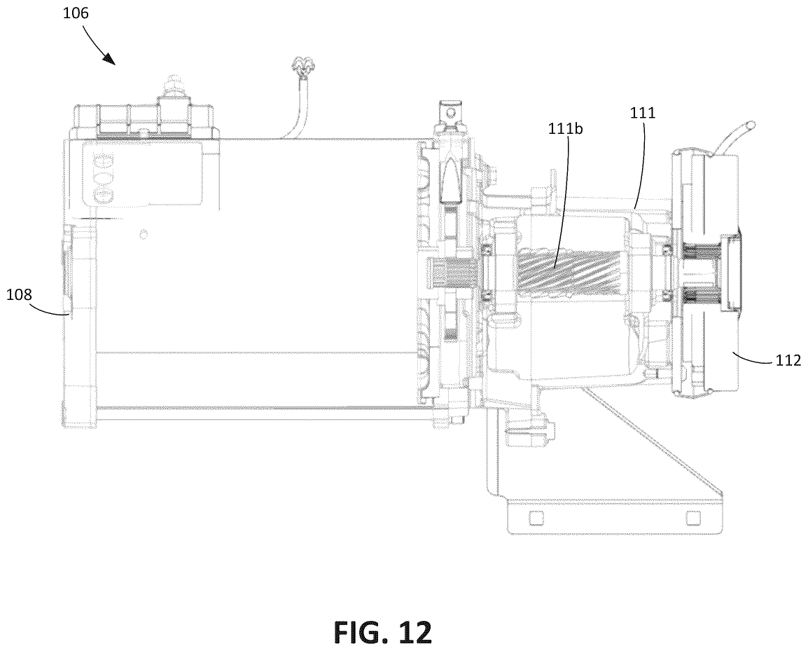

As further depicted in FIGS. 2 and 10 to 12, in some embodiments, the utility vehicle 100 includes an engageable parking brake mechanism 112. In the example shown, the parking brake mechanism is an electromagnetic brake that is spring biased into an engaged position to lock or brake the drive train absent the application of electrical power. With such a configuration, when electrical power is removed, such as by purposefully cutting off power or via the vehicle batteries being sufficiently depleted, the parking brake mechanism 112 engages to impede rotation of a drive shaft or electric motor of the utility vehicle 100, thereby inhibiting movement of the ground engaging members 110, ensuring the utility vehicle 100 remains stationary. In some embodiments, the electromagnetic parking brake mechanism 112 is set to default to the engaged position as a safety feature, serving to inhibit unintentional movement of the vehicle in the absence of power. Automatic engagement of the engageable parking brake mechanism 112 can be especially useful in situations where the vehicle is left unattended or in emergency power shutdown scenarios, providing a secure and reliable means to prevent movement of the ground engaging members 110 of the utility vehicle 100. With respect to the example shown at FIG. 11, an electromagnetic parking brake mechanism 112 is mounted to the transmission 111 on an opposite side of the electric motor 108 such that the parking brake mechanism 112 and the electric motor 108 are coaxially aligned, thereby allowing the parking brake mechanism 112 to engage with the electric motor 108. In some examples, and as shown at FIG. 12, the transmission 111 includes a geared drive shaft 111b that is received by the electric motor 108 at one end and that is received by the electromagnetic parking brake mechanism 112 at the opposite end. Although not depicted in FIG. 12, further gears are provided within the transmission 111 that are intermeshed with the geared shaft 111b and that connect to the output 111a to achieve the desired speed reduction ratio. In some examples, the shaft 111b can be formed as part of the electric motor 111.

While not illustrated in FIG. 1, certain embodiments of the utility vehicle 100 may additionally feature an implement 116. Such implements can encompass a variety of tools and attachments, including but not limited to an auger, hammer, chainsaw, backhoe, stump grinder, or ground leveler. This aspect of the design allows for a broad range of functionalities, accommodating different types of implements and attachments that can be integrated with the utility vehicle 100 to enhance its versatility in various applications.

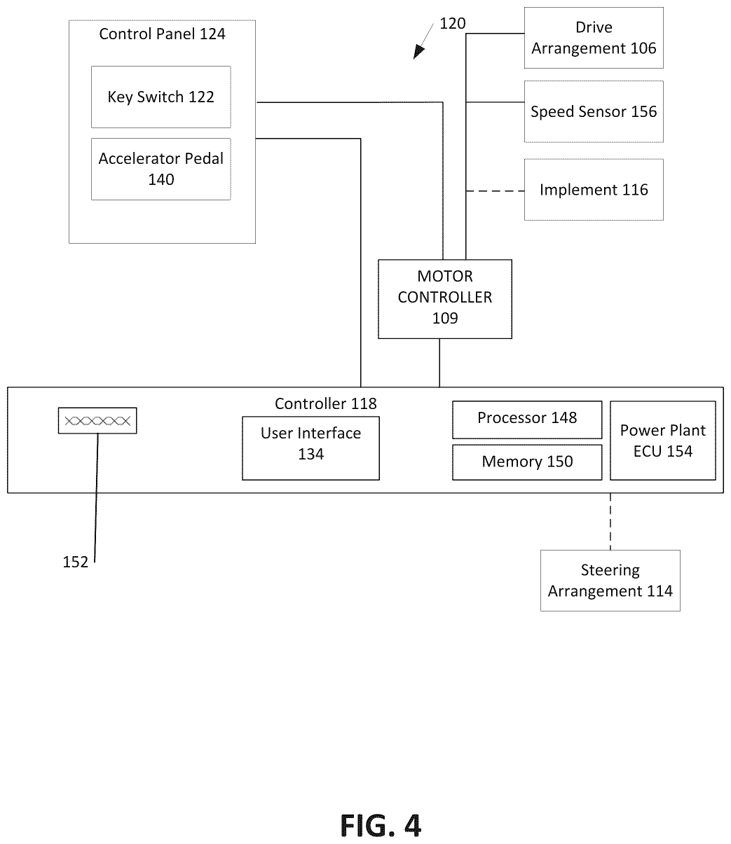

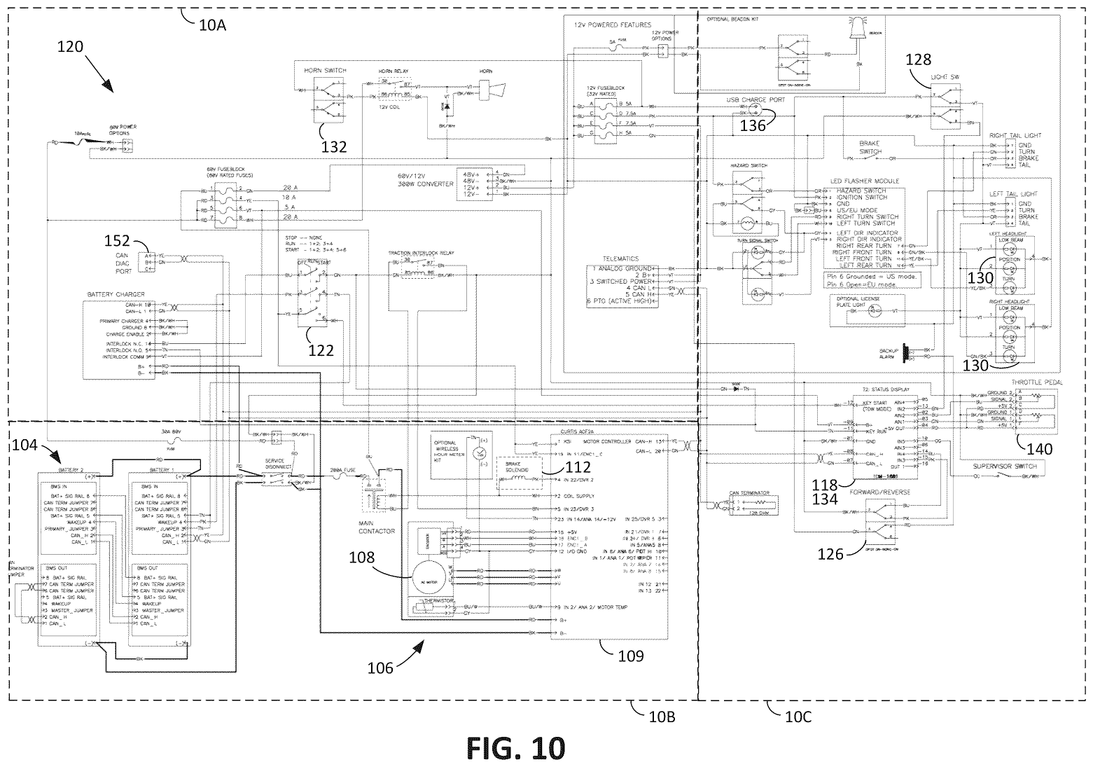

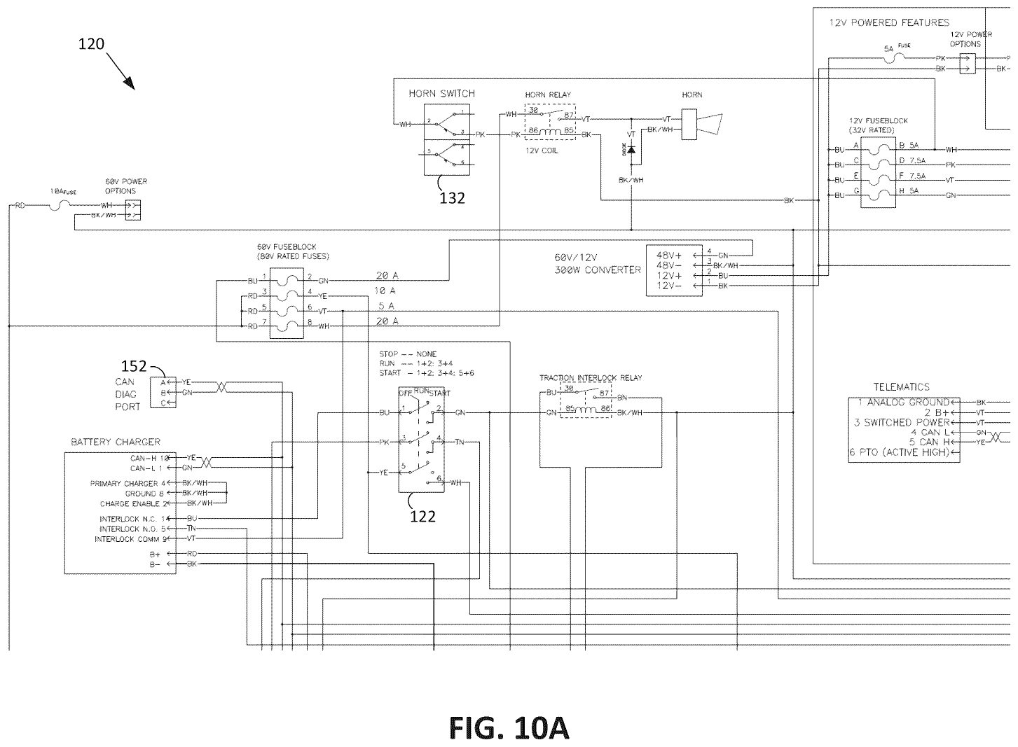

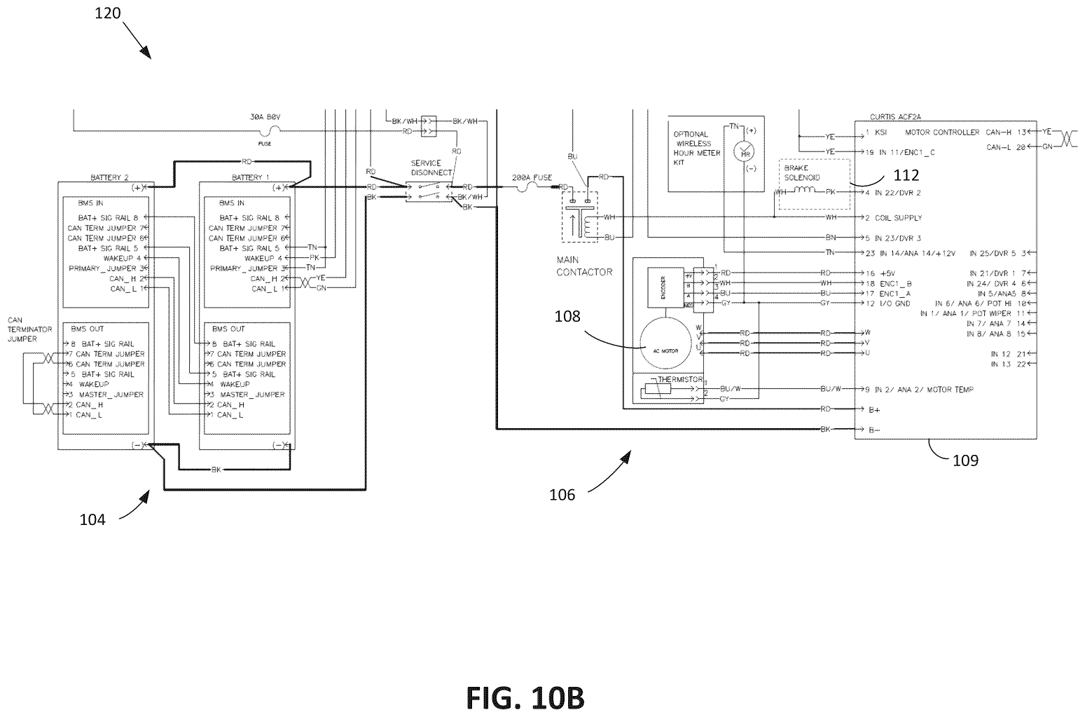

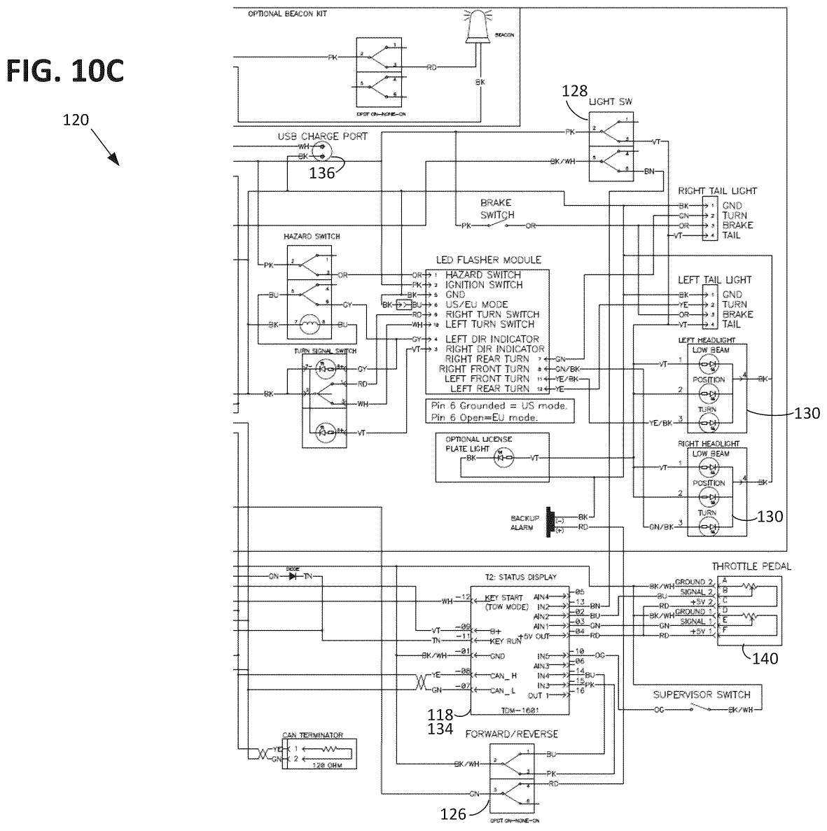

As additionally shown in FIG. 2, management and control of the drive arrangement 106, steering arrangement 114, and the implement 116 can be at least partially facilitated by an electronic controller 118. In some embodiments, user interaction with the electronic controller 118, such as switching between operational modes, can be enabled through a power control system 120 (as further depicted in FIGS. 4 and 10), which can include a key switch 122. In embodiments, the power control system 120 can integrate the key switch 122 as an interface for mode selection and basic command inputs to the electronic controller 118.

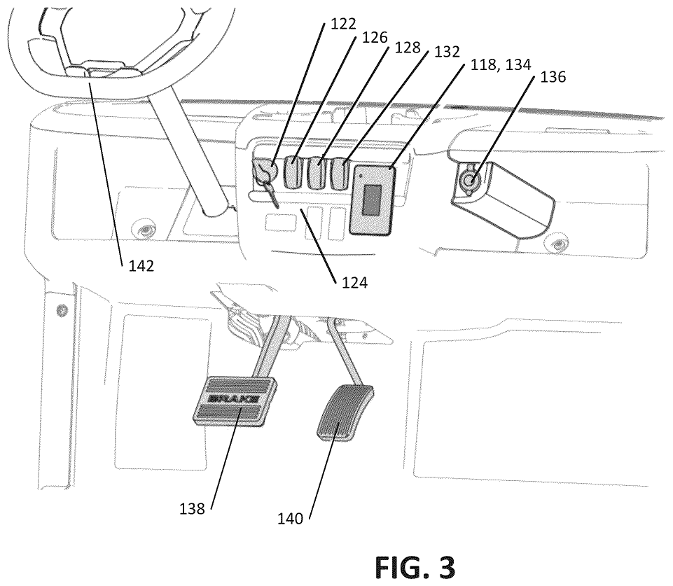

FIG. 3 presents a control panel 124 designed for intuitive user interaction and effective control of the utility vehicle 100, in accordance with embodiment of the disclosure. In embodiments, the control panel 124 can include a key switch 122 having multiple positions, with each position correlating to different operational modes governed by the electronic controller 118, enabling the user to easily switch between modes such as park, operation, and tow. Additionally, as depicted in FIGS. 3 and 10, in some embodiments, a direction selector 126 can be provided, enabling the user to choose between forward and reverse driving directions. For visibility and safety, a light switch 128 can be incorporated to control the exterior lights 130 of the utility vehicle 100. The control panel 124 can also feature a horn switch 132 for activating a horn.

In some embodiments, the control panel 124 can include a user interface 134 (alternatively referred to as a “display”), for real-time information regarding the vehicle's status and settings. Further, a USB or other data port 136 can be included, facilitating updating of software or maintenance troubleshooting or programming non-transitory computer-readable media of the electronic controller 118.

For operation of the drive arrangement 106, the control panel 124 can include a brake pedal 138 to engage a braking system, and an accelerator pedal 140 to control a speed of the utility vehicle 100, for example via the drive arrangement 106. For operation of the steering arrangement 114, the control panel 124 can include a steering wheel 142. In other embodiments, control of the drive arrangement 106 and steering arrangement 114 can be provided by other types of user inputs. These can include a steering wheel, pedal controls (such as accelerator and brake pedals), joystick, touchpad interfaces, voice command systems, toggle switches, buttons or dials for specific functions, and interactive displays or touchscreens that allow for gesture or touch control.

Referring to FIG. 4, the control components of the above-described utility vehicle 100 are shown in further detail. In one embodiment, an electronic controller 118 and motor controller 109 are provided for selectively operating the utility vehicle 100 in one of three modes, including: 1) a park mode, in which the engageable parking brake mechanism 112 is engaged; 2) an operation mode, in which the drive arrangement 106 is controllable to drive the utility vehicle 100 (e.g., in either of a forward or reverse direction); and 3) a tow mode, in which the engageable parking brake mechanism 112 can be disengaged to enable the utility vehicle 100 to be manually towed (e.g., moving the utility vehicle 100 without onboard power to the drive arrangement 106). In some embodiments, unimpeded rotation of the ground engaging members 110 can be enabled by placing the drive arrangement 106 in a neutral position such as through a command from the motor controller 109 to allow free rotation of the electric motor(s) 108. For example, the motor controller can disable one or more controls or algorithms that may ordinarily actively operate to maintain the motor speed at zero rpm under certain conditions such that the electric motor 108 will not prevent manual rolling and/or towing of the vehicle. In some embodiments, the drive arrangement 106 can be shifted to a neutral position, such as via a transmission, while the engageable parking brake mechanism 112 remains engaged. In embodiments where the drive arrangement 106 does not include a neutral position, applying rotational torque to the ground engaging members 110, while in the tow mode, can generate electrical power, potentially used for recharging the power supply 104. In some examples, the motor controller 109 is configured to both allow free rotation of the electric motor(s) 108 and to disengage the parking brake mechanism 112 when an input from the electronic controller 118, via the operation of the key switch 122, is received. The motor controller 109 can also be configured to provide an output to operate the parking brake mechanism 112, as is depicted at FIGS. 10-10C.

In some examples, the electronic controller 118 includes a processor 148 and a non-transient storage medium or memory 150, such as RAM, a flash drive, or a hard drive. Memory 150 is for storing executable code, the operating parameters, and the input from the control panel 124, while processor 148 is for executing the executable code. Memory 150 can also be for storing reference information such as maps and/or lookup tables. The electronic controller 118 is also shown as including a transmitting/receiving interface 152, such as a twisted pair wire connection or an Ethernet port for two-way communication with a WAN/LAN/CAN-BUS related to an automation system. The user interface 134 may be provided, for example as part of the control panel 124 to activate and deactivate the system, allow a user to manipulate certain settings or inputs to the electronic controller 118, and to view information about the system operation. Although not depicted, the motor controller 109 can be provided with the same features as the controller 118. However, in the example shown, the motor controller 109 is provided without a user interface 134.

The electronic controller 118 typically includes at least some form of memory 150. Examples of memory 150 include computer readable media. Computer readable media includes any available media that can be accessed by the processor 148. By way of example, computer readable media can include computer readable storage media and computer readable communication media. Computer readable storage media includes volatile and nonvolatile, removable and non-removable media implemented in any device configured to store information such as computer readable instructions, data structures, program modules, or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the processor 148.

Computer readable communication media typically embodies computer readable instructions, data structures, program modules, or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

With continued reference to FIG. 4, a power control system 120 is depicted in accordance with an embodiment of the disclosure. As depicted, the power control system 120 includes the interconnected electronic controller 118 and the motor controller 109, which are shown as having a number of inputs/outputs that may be used for operating the utility vehicle 100, which can be intermixed to achieve various functionalities. In an aspect, the electronic controller 118 can send commands to and receive feedback from a power plant electronic control unit 154. In some embodiments, the electronic controller 118 and motor controller 109 receive input data from the control panel 124, including at least the key switch 122 and the accelerator pedal 140. Additionally, the electronic controller 118 and/or motor controller 109 can receive input data from a speed sensor 156 or other type of sensor (e.g., position sensor, limit switch, accelerometer, data input from onboard motor controller with sensed or calculated speed value, etc.) to affect control of the electronic controller 118. In one example, the vehicle 100 is configured without a separate speed sensor 156, and the motor controller 109 is configured to calculate the vehicle speed based on a calculation using the electric motor rotational speed and known variables such as the transmission gear ratio and outer diameter of the tires of the vehicle 100. In turn, the electronic controller 118 and motor controller 109 can provide output information to the drive arrangement 106. In some embodiments, the electronic controller 118 and/or motor controller 109 can also provide output information to the steering arrangement 114 and implement 116.

In one or more embodiments, the exemplary systems, methods and interfaces may be implemented using one or more computer programs using a computer apparatus such as the processor 148 and memory 150. Program code and/or logic described herein may be applied to input data to perform functionality described herein and generate desired output information. The output information may be applied as an input to one or more other devices and/or methods as described herein or as would be applied in a known fashion.

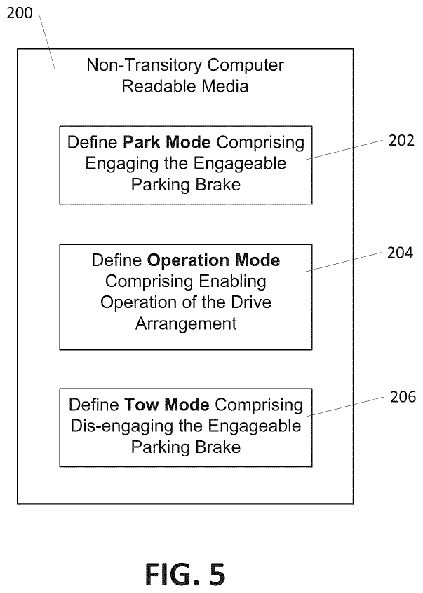

Referring to FIG. 5, a block diagram of an example non-transitory computer readable medium 200, including a set of instructions executable by a processor (e.g., processor 148), is depicted in accordance with an embodiment of the disclosure. In one embodiment, the non-transitory computer readable storage medium 200 is included in the memory (e.g., memory 150) of the electronic controller 118 and includes a set of instructions 202, 204, 206 executable by the processor 148. Instructions 202, 204, 206 can define the utility vehicle 100 modes of operation. For example, in one embodiment, the instructions 202, 204, 206 can correspond to a park mode, an operation mode, and a tow mode respectively.

According to the first instruction 202 (e.g., park mode), with the key switch 122 in a first position (e.g., an OFF position) which serves as a shut-off position for the utility vehicle 100, power to the drive arrangement 106 can be discontinued to conserve power. In some embodiments, rotating the key switch 122 counterclockwise to the OFF position prompts the electronic controller 118 to engage the engageable parking brake mechanism 112. In some embodiments, the engageable parking brake mechanism 112 can be automatically engaged upon the removal or discontinuation of electrical power, or a decrease in the electrical potential below a defined threshold (e.g., about 2.75 volts).

In some embodiments, the engageable parking brake mechanism 112 can serve as a failsafe mechanism, effectively inhibiting unintentional movement or rolling of the utility vehicle 100 when it is turned off or devoid of power. For example, in some embodiments, when the utility vehicle 100 is moving (e.g., forward or reverse) and comes to a stop, the engageable parking brake mechanism 112 can automatically engage. Furthermore, in some embodiments the utility vehicle 100 can include an independent transmission brake configured to engage when the utility vehicle 100 is in the park mode, enabling both the engageable parking brake mechanism 112 and the transmission brake to be simultaneously engaged.

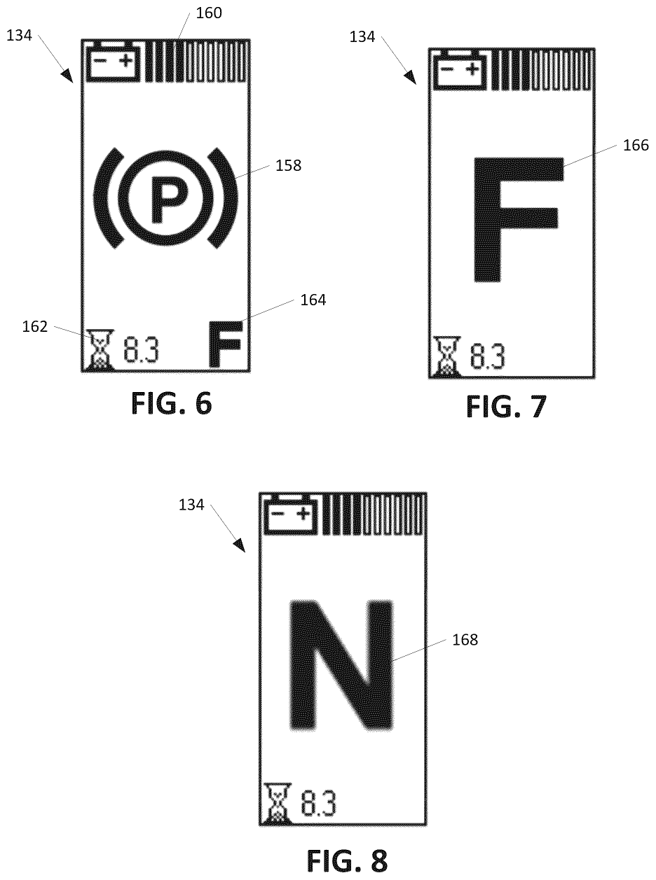

As depicted in FIG. 6, in some embodiments, a parking brake symbol 158 representing a status of the engageable parking brake mechanism 112 can be presented on the user interface 134. Other symbols included in the user interface 134 can include a battery charge level 160, hour meter 162, and direction 164 (e.g., indicating a selected direction when the key switch 122 is in the second position (e.g., an ON position)). In some embodiments, the key switch 122 can be transition from the OFF position to the ON position through clockwise (or alternatively counterclockwise) rotation.

According to the second instruction 204 (e.g., operation mode), with the key switch 122 in the second position (e.g., an ON position), the electronic controller 118 can be configured to selectively disengage the engageable parking brake mechanism 112. For example, in some embodiments, the engageable parking brake mechanism 112 can be released upon user manipulation of the accelerator pedal 140. Accordingly, in some embodiments, manually turning the key switch 122 from the OFF position to the ON position, and depressing the accelerator pedal 140 can cause the electronic controller 118 to disengage the engageable parking brake mechanism 112 and activate the drive arrangement 106 to propel the utility vehicle 100 in either of a forward or reverse direction, selectable via the direction selector 126. As depicted in FIG. 7, a drive symbol 166 representing a selected direction of the utility vehicle 100 can be presented on the user interface 134 to confirm operation of the electronic controller 118 in the operation mode. In some embodiments, when the utility vehicle 100 is traveling in forward or reverse and comes to a stop, the engageable parking brake mechanism 112 can automatically engage. The engageable parking brake mechanism 112 can be subsequently disengaged by pressing on the accelerator pedal 140.

According to the third instruction 206 (e.g., tow mode), with the key switch in the third position (e.g., a TRANSPORT position), the electronic controller 118 can be configured to disengage the engageable parking brake mechanism 112 and/or ensure that the drive arrangement 106 is in a neutral position, enabling the utility vehicle 100 to be manually rolled in either of a forward or reverse direction. In some embodiments, the key switch 122 can be transitioned from the ON position to the TRANSPORT position through clockwise (or alternatively counterclockwise) rotation. In some embodiments, the key switch 122 can be rotationally biased away from the TRANSPORT position (e.g., a spring can resist rotation to the TRANSPORT position), such that a user must manually hold the key switch 122 in the TRANSPORT position for a required period of time to engage the tow mode.

As depicted in FIG. 8, a neutral symbol 168 can be presented on the user interface 134 to confirm operation of the electronic controller in the tow mode. Thereafter, the neutral symbol 168 can be relocated on the user interface 134 (e.g., to a lower corner) with a speed of the utility vehicle displayed on the user interface 134.

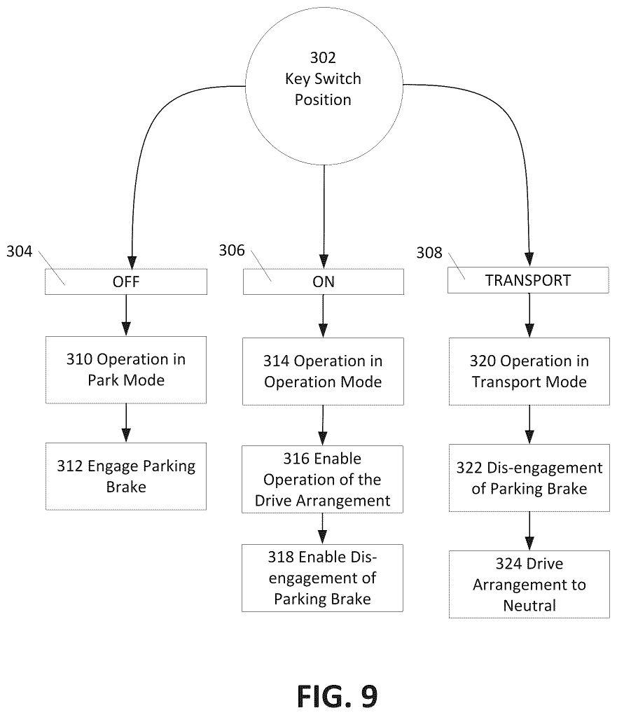

Referring to FIG. 9, a diagrammatic illustration of an example method 300 of controlling a utility vehicle 100, is depicted in accordance with an embodiment of the disclosure. At step 302, a position of the key switch 122 can be identified. For example, in some embodiments, at step 304 it can be determined that the key switch 122 is in a first, OFF position, alternatively at step 306 it can be determined that the key switch 122 is in a second, ON position, alternatively, at step 308 it can be determined that the key switch 122 is in a third, TRANSPORT position.

At step 304, when it is determined that the key switch 122 is in the first, OFF position, at step 310, the electronic controller 118 can operate in a park mode (e.g., including shutting down, un-powering, etc.), which at step 312, can cause a cessation in electrical power to the engageable parking brake mechanism 112 (e.g., resulting in automatic engagement at the engageable parking brake mechanism 112). In other embodiments, the electronic controller can actively instruct the engageable parking brake mechanism 112 to transition to an engaged configuration to inhibit rotation of the ground engaging members 110.

At step 306, when it is determined that the key switch 122 is in the second, ON position, at step 314, the electronic controller 118 can operate in the operation mode, which at step 316 can enable operation of the drive arrangement (e.g., via selection of a direction via the direction selector 126 and pressing the accelerator pedal 140). Additionally, at step 318, the electronic controller 118 can enable disengagement of the engageable parking brake mechanism 112 (e.g., upon pressing the accelerator pedal 140).

At step 308, when it is determined that the key switch 122 is in the third, TRANSPORT position, at step 320, the electronic controller 118 can be operated in the transport mode (e.g., tow mode), which at step 322, can command the engageable parking brake mechanism 112 to disengage, and at step 324, configure the drive arrangement 106 to a neutral position, thereby enabling the utility vehicle 100 to be manually moved or transported. In some examples, the tow mode can be terminated by returning the key switch to the OFF position.

In some examples, the key switch 122 is a spring-return type switch in which the switch returns to the ON position after an operator has rotated the key to the TRANSPORT position and has subsequently released the key. When the key switch 122 is so configured, step 308 can include determining that the key switch has been held in the TRANSPORT position for a predetermined length of time, for example 5 seconds, before engagement and operation of the tow mode is allowed. In some examples, the neutral symbol 168 is displayed on the user interface 134 to provide the operator with feedback that key switch has been held in the transport position for a sufficient length of time to engage the tow mode. Once the tow mode is initiated and the key is released, the key switch spring returns to the ON position. In some examples, the tow mode can be terminated from the ON key switch position by operating the key switch to the OFF position and then to the ON position.

With reference to FIG. 10, a comprehensive 12V and 60V electrical system 120 for the utility vehicle is presented. In one aspect, FIGS. 10-10C illustrate an electronically controlled brake system that includes both service braking and parking brake functions, with the parking brake system designed to be in a locked state when deenergized. A key feature shown in the schematic is the ignition switch system, which includes stop, run, and start positions, corresponding to the vehicle's above-described various operational modes including the tow mode functionality. The system 12 is further shown as including a number of other aspects. For example, the system 120 includes multiple safety interlocks and diagnostic capabilities through a dedicated CAN diagnostic port. The schematic further shows two main power systems: a 12V system for auxiliary features and a 60V system for primary vehicle operations. The 12V powered features include a beacon kit, horn system, USB charging port, and lighting systems. These components are protected by various fuses rated at different amperage levels (5 A, 7.5 A, 10 A, 20 A) and are controlled through switches on the control panel. The lighting system includes headlights, tail lights, turn signals, and an optional license plate light. The 60V system, which is the primary power system, includes the main battery configuration, motor controller (Curtis ACF2A), and electronic brake components. A 60V/12V 300W converter bridges the two power systems. The schematic shows the integration of safety features including the traction interlock relay, brake solenoid, and the electromagnetic parking brake system. The motor control system includes a throttle pedal input and various sensor connections for operational control. The schematic also details the CAN (Controller Area Network) communication system that connects various electronic control units, including the telematics system and the TDM-1601 controller. While the depicted electrical system 120 reveals a number of other aspects and advantages of the present disclosure, the depicted schematic 120 represents one example embodiment and should not be considered limiting in this respect.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

What is claimed is:

1. A utility vehicle comprising:
a) a chassis supported by a plurality of ground engaging members;
b) a power supply;
c) a drive arrangement including an electric motor coupled to at least one of the plurality of ground engaging members;
d) an electromagnetic parking brake mechanism; and
e) a controller for selectively operating the utility vehicle in one of three modes, including:
i) a park mode, wherein the electromagnetic parking brake mechanism is engaged;
ii) an operation mode, wherein the electromagnetic parking brake mechanism is disengaged and the drive arrangement is controllable to drive the utility vehicle; and
iii) a tow mode, wherein the electromagnetic parking brake mechanism is disengaged to enable the utility vehicle to be manually rolled.

2. The utility vehicle of claim 1, wherein the drive arrangement includes a transmission coupled to the electric motor and the electromagnetic parking brake mechanism.

3. The utility vehicle of claim 1, further comprising a key switch having a plurality of positions, wherein the plurality of positions include an OFF position, an ON position, and a TRANSPORT position corresponding to the park mode, operation mode, and tow mode of the controller.

4. The utility vehicle of claim 1, wherein when the controller is in the park mode, the electromagnetic parking brake mechanism is engaged to inhibit rotation of one or more driven ground engaging members.

5. The utility vehicle of claim 4, wherein when the controller is in the operation mode, the electromagnetic parking brake mechanism is disengaged to enable the electric motor to drive the one or more driven ground engaging members upon pressing an accelerator pedal.

6. The utility vehicle of claim 1, wherein the controller transitions to the tow mode only when a speed of the utility vehicle is less than or equal to a predetermined speed.

7. The utility vehicle of claim 3, wherein the key switch is a spring-return type switch and wherein the controller transitions to the tow mode only when the key switch is held in at least one of the plurality of positions for a predetermined length of time.

8. The utility vehicle of claim 1, wherein when the controller is in the tow mode, electrical power from the power supply is applied to the electromagnetic parking brake mechanism to disengage the electromagnetic parking brake mechanism.

9. The utility vehicle of claim 2, wherein the transmission is located between the electric motor and the electromagnetic parking brake mechanism.

10. The utility vehicle of claim 1, further comprising a user interface to visually indicate when the controller is in the tow mode.

11. A method of operating a utility vehicle, the method comprising:
a) providing a utility vehicle having a power supply, a drive arrangement, an electromagnetic parking brake mechanism that is in a locked state when deenergized, and a key switch having an OFF position, an ON position, and a TRANSPORT position;
b) rotating the key switch from the OFF position to the TRANSPORT position;
c) holding the key switch in the TRANSPORT position for a predetermined length of time;
d) confirming a speed of the utility vehicle is below a predetermined threshold speed; and
e) transitioning the utility vehicle to a tow mode by:
i) disengaging the electromagnetic parking brake mechanism; and
ii) configuring the drive arrangement to enable manual rolling of the utility vehicle.

12. The method of claim 11, wherein the predetermined length of time is about 5 seconds.

13. The method of claim 11, wherein the predetermined threshold speed is about 1 mile per hour.

14. The method of claim 11, further including displaying a neutral symbol on a user interface to indicate the utility vehicle is in the tow mode.

15. The method of claim 11, wherein disengaging the electromagnetic parking brake mechanism includes applying electrical power from the power supply to the electromagnetic parking brake mechanism.

16. The method of claim 15, wherein the electromagnetic parking brake mechanism is disengageable when the power supply has a charge of at least about 2.75 volts.

17. The method of claim 11, further comprising:
a) releasing the key switch after the predetermined length of time; and
b) allowing the key switch to return to the ON position while maintaining the utility vehicle in the tow mode.

18. The method of claim 11, further comprising:
a) terminating the tow mode by rotating the key switch to the OFF position.

19. The method of claim 18, further comprising:
a) automatically engaging the electromagnetic parking brake mechanism upon termination of the tow mode.

20. The method of claim 11, wherein configuring the drive arrangement includes placing a transmission of the drive arrangement in a neutral position.
